(19) United States
(12) Patent Application Publication
(10) Pub. No.: US 2003/0140593 A1
(43) Pub. Date: Jul. 31, 2003

(54) Method of securing a framed panel

(76) Inventor: Simon Trundle, Grendon (GB)

Correspondence Address: BAKER + HOSTETLER LLP, WASHINGTON SQUARE, SUITE 1100, 1050 CONNECTICUT AVE. N.W., WASHINGTON, DC, 20036-5304, US

(21) Appl. No.: 10/220,815

(22) PCT Filed: Mar. 8, 2001
(86) PCT No.: PCT/GB01/01019

(30) Foreign Application Priority Data
Mar. 8, 2000 (GB) 0005595.4

(51) Int. Cl. E06B 3/26; E04B 1/00; E04G 23/00; E04G 21/00

(52) U.S. Cl. 52/741.3; 52/202

(57) ABSTRACT

A framed panel (1) consists of a panel (2) mounted in a frame (3). In order to secure the panel, a shock cord (4) is fastened across the panel (2), one or both ends of the shock cord (4) being held in a cleat (6a, 6b), so that the panel (2) is arrested when subjected to shock.

The present invention relates to a method of securing a framed panel subjected to shock, for example, high winds and explosions, and also to a framed panel so secured.

Framed panels made of shattering materials tend to shatter when subjected to shock and the shattered fragments of the panels may be propelled at high speeds into the room in which he framed panel is located, causing injury to personnel and/or damage to the room.

Non-shattering panels, such as panels made of laminated glass, polycarbonates or glass coated in protective film, are frequently used to prevent such injury to personnel and damage to property, and are generally effective for this purpose. However, it is not uncommon, eg during an external explosion, for the entire panel, whether made of shattering or non-shattering material, to be forced out of the frame and to travel at high speed into the room in which it is located. This is particularly problematic when the panel is held in a relatively weak frame, such as a timber frame. Such panels can travel at up to 10 m/s (approximately 30 feet per second) and can cause serious injury to personnel, as well as significant damage to property.

Attempts have been made to arrest the movement of such a panel from the surrounding frame by reinforcing the frame with steel bars. However, it has been found that such steel bars can also be forced away from the frame and driven into the room at high speed, potentially causing serious injury to personnel and damage to property.

An object of the present invention is to provide a method for securing a framed panel subjected to shock, in which the above disadvantages are overcome.

The invention provides a method of securing a framed panel as claimed in claim 1. The invention also provides a secured framed panel claimed in claim 17.

The invention is particularly applicable to the petrochemical industry, in which explosions are relatively common. The framed panel to be secured is preferably made of a non-shattering material. In a preferred embodiment of the invention, the shock cord has a maximum elasticity of 10%.

The ends of the shock cord an preferably protected. In a preferred embodiment the ends of the shock cord are protected by heat shrinking. Alternatively, the ends of the shock cord are protected by a cap on the cleat.

The cleat is preferably attached to the frame. In a preferred embodiment, the cleat is attached to the frame by means of one or more buttress screws. In a further preferred embodiment of the invention the shock cord is held at both ends by a cleat.

The panel to be secured is preferably made of a polycarbonate material. In a preferred embodiment the panel is a window and is made of laminated glass. Alternatively, the window is made of glass covered by window film. The shock cord is preferably a polyester braided rope. In a further preferred embodiment, two or more shock cords are arranged across the panel.

Embodiments of the invention will now be described with reference to the accompanying drawings, in which:

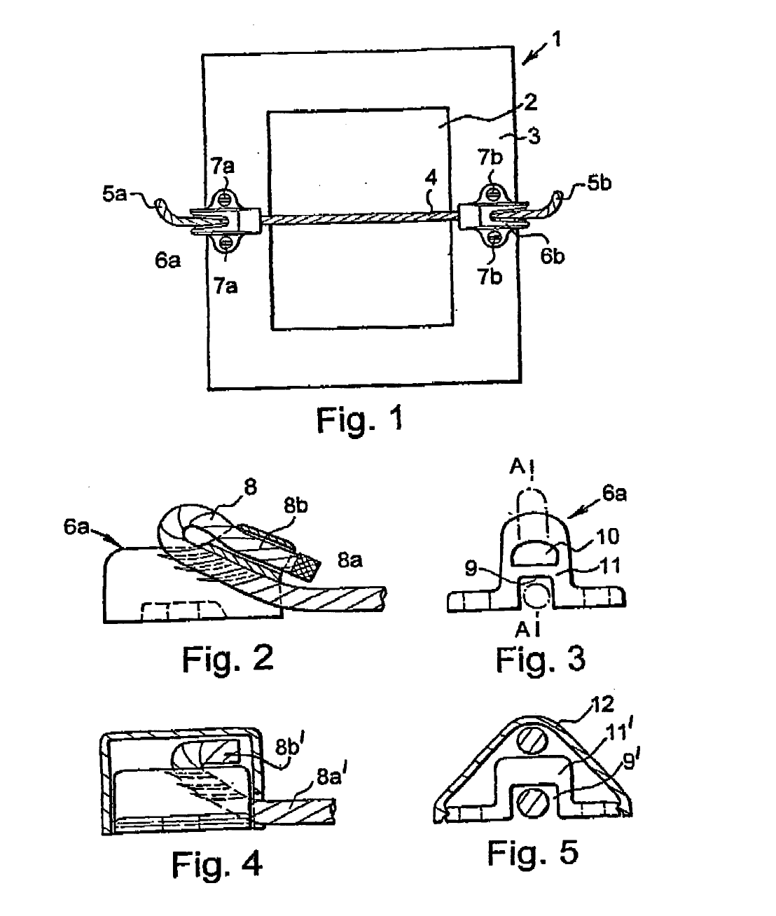

FIG. 1 is a front view of a framed panel secured in accordance with the invention;

FIG. 2 is a side view of one end of a shock cord held in a cleat;

FIG. 3 is an end view of the cleat of FIG. 2;

FIG. 4 is a side view of one end of a shock cord held in an alternative cleat with a cover and;

FIG. 5 is an end view of the shock cord and cleat of FIG. 4.

In FIG. 1 a secured framed panel 1 has a non-shattering panel 2 mounted in a frame 3. The term “non-shattering” refers to a material which does not shatter when subjected to shock, but also includes materials which do shatter but are provided with means for holding the shattered pieces together, such as window film, so that the shattered pieces remain joined together in such a way that the shattered panel retains substantially the same shape as in the unshattered state.

A flexible shock cord 4 is arranged across the framed panel 1, at such a height on the framed panel as to adequately support the framed panel 1. The ends 5a and 5b of the shock cord 4 are located in cleats 6a and 6b, respectively, attached to the frame 3. Alternatively, the cleats 6a and 6b may be attached to the wall in which the framed panel is mounted. The cleats 6a and 6b are attached by means of buttress screws 7a and 7b, respectively. Buttress screws have a relatively high pull-out pressure and are thus well-suited for this application, in which the loads to which the framed panels are subjected are relatively high. However, it is possible to attach the cleats by means of other screws.

FIGS. 2 and 3 show the arrangement of the end 5a of the shock cord 4 in the cleat 6a in detail. It will be appreciated that the arrangement of the end 5b in cleat 6b will be similar. The end 5a of the shock cord 4 is arranged as a loop 8 having opposing sides 8a and 8b. The side 8a of the loop 8 is arranged in a recess 9 in the cleat 6a and the opposing side 8b is arranged in a channel 10 in the cleat 6a. The channel 10 is arranged above the recess 9 and is substantially parallel thereto. The recess 9 and channel 10 are located on the central vertical plane A-A of the cleat 6a and are separated by a dividing portion 11. The end 5a of the shock cord 4 has been treated by heat shrinking to prevent unravelling of the cord 4.

FIGS. 4 and 5 show the arrangement of the end 5a of the shock cord 4 in an alternative cleat 6a¹. Again, the end 5a of the shock cord is arranged as a loop 8¹ having opposing sides 8a¹ and 8b¹. The side 8a¹ is arranged in a recess 9¹ and the opposing side 8b¹ is arranged above a dividing portion 11¹. A cap 12 is arranged around the cleat 6a¹ and the side 8b¹, so that the end of the shock cord 4 is completely covered to protect the end of the shock cord.

When the framed panel 1 is subjected to shock, such as a gust of strong wind or an explosion, the panel 2 starts to move away from the frame 3. The shock cord arrests the movement of the panel 2 and prevents it from travelling at high speed into the interior of the room, in which it is located. Although, in extreme cases, the panel 2 may fall into the interior of the room, it is likely to fall close to the frame 3 and not travel across the room. The shock cord 4 also stretches and absorbs a significant portion of the energy of the explosion or gust of wind, thus reducing the load on the frame 2. In the event that the shock cord 4 is forced out of the cleats 6a and 6b, the damage caused by the shock cord will be minimal in comparison to the damage that would be caused if a steel bar were to be used.

A number of different cleats can be used to hold the shock cord 4 but the “CL255 Omega” cleat manufactured by Clamcleats Limited of Watchmead, Welwyn Garden City, Hertfordshire, AL71AP, England, and covered by UK patent No. 2 299 366 is particularly suitable. This type of cleat wedges the shock cord 4 in a groove. However, alternative types of cleat, such as T-shaped cleats, in which the shock cord 4 is wound around the cleat, would also be suitable. The shock cord 4 is a braided polyester/nylon interlayer with a woven polyester shield. However, any other suitable shock cord, such as an elasticated rubber (bungee) shock cord, may be used. Suitable shock cords generally have a maximum elasticity of 10%. However, it has been found that shock cords having higher elasticity can still be effective, provided that the pressures applied to the system are relatively low.

In the embodiments described above each end of the shock cord 4 is held in a cleat. However, it is possible for only one end of the shock cord 4 to be held in a cleat, the other end being held by another device, for example, a clamp. Similarly, while two buttress screws are used to hold each cleat in the present embodiment, it would be possible to secure a cleat of suitable design using one screw only.

In the embodiment described above, one shock cord is arranged horizontally across the framed panel. In taller flannel panels, it may, however, be necessary to use several shock cords, arranged one above the other. Alternatively, a shock cord can be arranged either vertically or diagonally across the framed panel.

The method can be applied to existing framed panels relatively quickly and inexpensively, particularly in comparison with steel bars.

1. A method of securing a framed panel including a panel mounted in a frame, the method comprising fastening a shock cord across the panel, wherein an end of the shock cord is held in a cleat, so that the panel is arrested when subjected to shock.

2. A method as claimed in claim 1, wherein the panel is made of non-shattering material.

3. A method as claimed in claim 1 or 2, wherein the shock cord has a maximum elasticity of 10%.

4. A method as claimed in any one of the preceding claims, wherein the ends of shock cord are protected.

5. A method as claimed in claim 4, wherein the ends of the shock cord are protected by heat shrinking.

6. A method as claimed in claim 4, wherein the ends of the shock cord are protected by cap on the cleat.

7. A method as claimed in any one of the preceding claims, wherein the cleat is attached to the frame.

8. A method as claimed in claim 7, wherein the cleat is attached to the frame by means of one or more buttress screws.

9. A method as claimed in any one of the preceding claims, wherein the shock cord is held at both ends by a said cleat.

10. A method as claimed in any one of the preceding claims, wherein the panel is made of a polycarbonate material.

11. A method as claimed in any one of the preceding claims, wherein the panel is a window.

12. A method as claimed in claim 11, wherein the panel is made of laminated glass.

13. A method as claimed in claim 11, wherein the panel is made of glass covered by window film.

14. A method as claimed in any one of the preceding claims, wherein the shock cord is a polyester braided rope.

15. A method as claimed in any one of the preceding claims, wherein two or more said shock cords are arranged across the panel and held in respective cleats.

16. A method substantially as herein described according to any one of the embodiment shown in the accompanying drawings.

17. A framed panel secured by a method as claimed in any one of the preceding claims.

18. A secured framed panel substantially as herein described with reference to any one of the embodiments shown in the accompanying drawings.
